(19) United States
(12) Patent Application Publication
(10) Pub. No.: US 2008/0134244 A1
(43) Pub. Date: Jun. 5, 2008

(54) BROADCAST RECEIVING SYSTEM

(75) Inventor: Naoki YAMAMOTO, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/947,308

(22) Filed: Nov. 29, 2007

(30) Foreign Application Priority Data
Dec. 1, 2006 (JP) 2006325412

(51) Int. Cl. G06F 3/00

(52) U.S. Cl. 725/44

(57) ABSTRACT

A broadcast receiving system includes a broadcast receiving device and a remote control. The broadcast receiving device receives television broadcasts. The broadcast receiving device includes a program information storage component, a search component and an output component. The program information storage component stores program information for receivable programs. The program information has channel information and program schedule information. The search component searches for a matching program out of the receivable programs based on the program schedule information. The output component outputs the channel information corresponding to the matching program. The remote control communicates with the broadcast receiving device. The remote control includes a display component and a display control component. The display control component acquires the channel information outputted by the output component and display the channel information on the display component.

### CROSS-REFERENCE TO RELATED APPLICATIONS

This application claims priority to Japanese Patent Application No. 2006-325412 filed on Dec. 1, 2006. The entire disclosure of Japanese Patent Application No. 2006-325412 is hereby incorporated herein by reference.

### BACKGROUND OF THE INVENTION

1. Field of the Invention

The present invention generally relates to a broadcast receiving system. More specifically, the present invention relates to a broadcast receiving system for receiving a television broadcast.

2. Background Information

Broadcast receiving devices receive television broadcasts and output the television broadcasts to monitors so that the television broadcasts are visible from outside. The number of channels that can be viewed has been increasing with an increase of popularity of digital broadcasts. Thus, users have to spend more time selecting the channels the users wish to watch.

With some conventional digital broadcast receiving devices, a notification message that a notification program exists is displayed on a screen using an OSD (see Japanese Laid-Open Patent Application 2003-9033). The notification program is a program having genre information preset by the user. Furthermore, the notification program is a program which starts within 1 minute. If the notification program exists, then the conventional digital broadcast receiving devices produce the notification message, such as “XYZ program will begin on channel 123”.

However, with the conventional digital broadcast receiving devices, since the notification message is inserted as the OSD on the screen, viewing of a noteworthy scene, such as a decisive scene, an exciting scene, or the like, is hindered. On the other hand, if the notification message is displayed small enough that the notification message does not hinder the viewing, then the user may miss seeing the notification message.

In view of the above, it will be apparent to those skilled in the art from this disclosure that there exists a need for an improved television receiving system. This invention addresses this need in the art as well as other needs, which will become apparent to those skilled in the art from this disclosure.

### SUMMARY OF THE INVENTION

The present invention was conceived in light of the above-mentioned problems. One object of the present invention is to provide a broadcast receiving system with which viewing of a program is ensured and channel selection is more convenient.

In accordance with one aspect of the present invention, a broadcast receiving system includes a broadcast receiving device and a remote control. The broadcast receiving device is configured to receive television broadcasts. The broadcast receiving device includes a program information storage component, a search component and an output component. The program information storage component is configured to store program information for receivable programs that are receivable. The program information has channel information identifying channels of the receivable programs and program schedule information indicating schedules of the receivable programs. The search component is configured to search for a matching program out of the receivable programs based on the program schedule information. The search component is configured to acquire the channel information corresponding to the matching program. The output component is configured to output the channel information corresponding to the matching program. The remote control is configured to communicate with the broadcast receiving device. The remote control includes a display component and a display control component. The display control component is configured to acquire the channel information outputted by the output component and display the channel information on the display component.

With the broadcast receiving system of the present invention, it is possible to provide a broadcast receiving system with which viewing of a program is ensured and channel selection is more convenient.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a diagram illustrating a broadcast receiving system in accordance with one embodiment of the present invention;

FIG. 2 is a block diagram illustrating a broadcast receiver in accordance with one embodiment of the present invention;

FIG. 3 is a plan view of a remote of the broadcast receiving system illustrated in FIG. 1;

FIG. 4 is a block diagram illustrating the remote illustrated in FIG. 3;

FIG. 5 is a block diagram illustrating a functional configuration of the broadcast receiving system illustrated in FIG. 1;

FIG. 6 is a flowchart illustrating an operation of the broadcast receiver illustrated in FIG. 2; and

FIG. 7 is a screen shot illustrating a matching program display screen displayed on the remote illustrated in FIG. 3.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

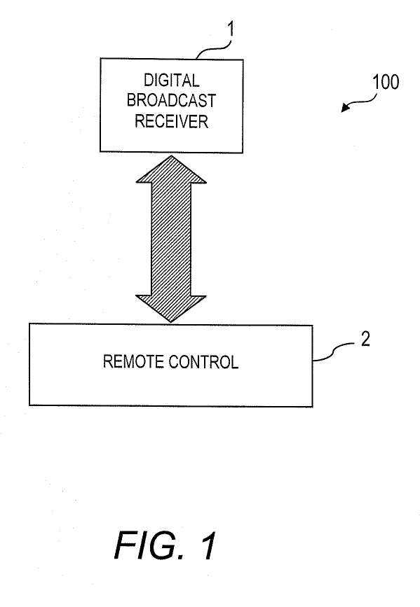

FIG. 1 is a block diagram illustrating a digital broadcast receiving system 100. The digital broadcast receiving system 100 includes a digital broadcast receiver 1 (e.g., broadcast receiving device) and a remote controller 2 (hereinafter referred to as “remote”). The digital broadcast receiver 1 is communicably connected to the remote 2 via infrared communication.

The digital broadcast receiver 1 is configured so as to receive an operation input from the user via the remote 2. The digital broadcast receiver 1 receives a television broadcast and outputs the television broadcast to display. The digital broadcast receiver 1 sends various kinds of information, such as channel information, genre information, character information, etc., to the remote 2 through the infrared communication.

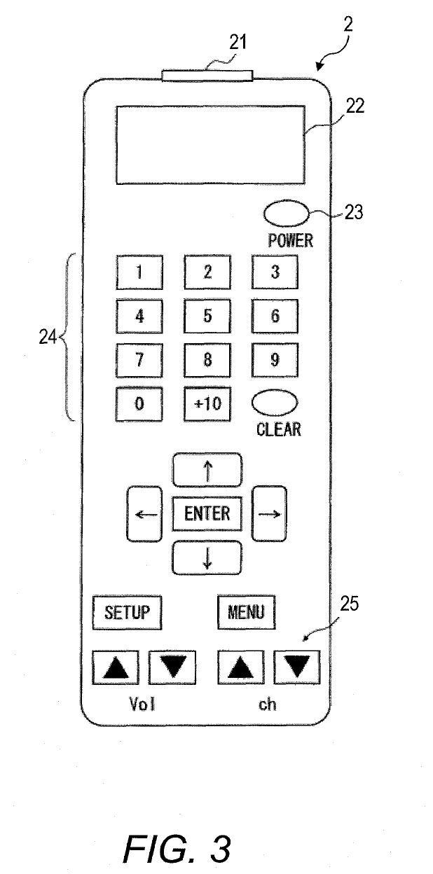

The remote 2 receives the operation input from the user. The remote 2 produces an infrared signal corresponding to the operation input. Then, the remote 2 outputs the infrared signal to the digital broadcast receiver 1. The remote 2 also receives various kinds of information, such as the channel information, the genre information, the character information, etc., from the digital broadcast receiver 1 through the infrared communication. Furthermore, the remote 2 outputs the information to a second display 22 shown in FIG. 3.

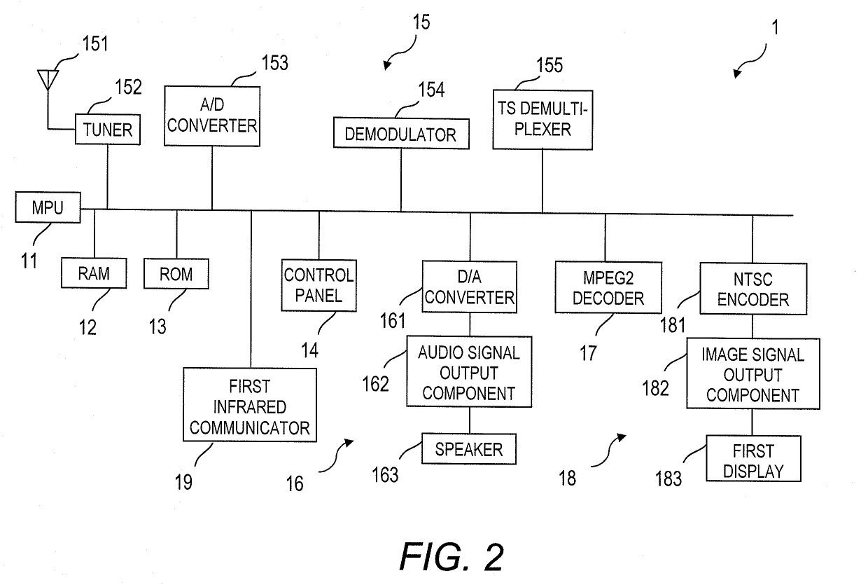

FIG. 2 is a block diagram illustrating the digital broadcast receiver 1. The digital broadcast receiver 1 includes an MPU (Micro Processing Unit) 11, a RAM (Random Access Memory) 12, a ROM (Read Only Memory) 13, a control panel 14, a reception component 15, an audio output component 16, an MPEG2 (Motion Picture Experts Group) decoder 17, an image output component 18 and a first infrared communicator 19.

The MPU 11 controls an operation of the entire digital broadcast receiver 1. The RAM 12 readably and writably stores information such as audio information and video information. The ROM 13 stores a control program for operating the MPU 11, for example.

The control panel 14 is used to perform various operations, such as turning the power on and off, and changing the channel. The reception component 15 receives and demodulates television broadcasts. The reception component 15 includes an antenna 151, a tuner 152, an A/D converter 153, a demodulator 154, and a TS (Transport Stream) demultiplexer 155.

The antenna 151 receives television broadcast waves. The tuner 152 tunes in a preset channel from the television broadcast waves received by the antenna 151. The A/D converter 153 converts an analog output signal of the tuner 152 into a digital signal. The demodulator 154 demodulates output information from the A/D converter 153. The TS demultiplexer 155 separates the output information demodulated by the demodulator 154 by type, and outputs audio information and video information.

The audio output component 16 outputs the audio corresponding to the television broadcast received by the reception component 15. The audio output component 16 includes a D/A converter 161, an audio signal output component 162 and a speaker 163. The D/A converter 161 converts the audio information outputted from the TS demultiplexer 155 (digital information) into an analog audio signal. The audio signal output component 162 outputs the analog audio signal to the speaker 163. The speaker 163 outputs audio corresponding to the analog audio signal.

The MPEG 2 decoder 17 decodes the video information outputted from the TS demultiplexer 155 into pre-compression video information.

The image output component 18 outputs the video information decoded by the MPEG2 decoder 17. The image output component 18 includes an NTSC (National Television Standards Committee) encoder 181, an image signal output component 182 and a first display 183. The NTSC encoder 181 converts the video information decoded by the MPEG2 decoder 17 into an NTSC-format television signal. The image signal output component 182 outputs the NTSC-format television signal to the first display 183. The first display 183 is a display device such as an LCD (Liquid Crystal Display), PDP (Plasma Display Panel), or the like. The first display 183 displays video corresponding to the NTSC-format television signal outputted from the image signal output component 182.

The first infrared communicator 19 is used to handle various operations from the remote 2, such as turning the power on and off, changing the channel, and changing the settings (such as viewing control settings) of the digital broadcast receiver 1. The first infrared communicator 19 also outputs the channel information, the genre information, the character information, and so forth to the remote 2.

The digital broadcast receiver 1 receives the television broadcasts as follows. First, a transmitted digital broadcast wave is received by the antenna 151. When the remote 2 (or the control panel 14) is used to select a channel, switching of a transponder received by the tuner 152 is performed. The received digital broadcast wave is converted into digital information by the A/D converter 153, and demodulated by the demodulator 154.

The digital broadcast wave is transmitted from a transmitting side (transmitting station) as a TS (Transport Stream) packet. The TS packet includes the video information, the audio information, control information including program information, and so forth. The video information, the audio information and the control information are separated and outputted by the TS demultiplexer 155. Then, the video information, the audio information and the control information are stored in the RAM 12. The audio information is read out from the RAM 12, and is converted into an analog audio signal by the D/A converter 161. Then, audio is outputted from the speaker 163 via the audio signal output component 162.

Also, the video information is read out from the RAM 12, and is decoded into pre-compression video information by the MPEG2 decoder 17. Then, the pre-compression video information is converted into an NTSC-format television signal by the NTSC encoder 181. Then, a video image is displayed on the first display 183 via the image signal output component 182.

FIG. 3 is a plan view of the remote 2. The remote 2 includes a second infrared communicator 21, a second display 22 (e.g., display component), a power key 23, a number pad 24, and channel key 25. The second infrared communicator 21 produces an operation signal corresponding to a key pressed by the user. The second infrared communicator 21 converts the operation signal to the infrared signal. Then, the second infrared communicator 21 outputs the infrared signal to the digital broadcast receiver 1. The infrared communicator 21 also receives the infrared signals corresponding to the channel information, the genre information, the character information, and so forth from the digital broadcast receiver 1.

The second display 22 includes an LCD or the like. The second display 22 displays the channel information, the genre information, the character information, and so forth received from the digital broadcast receiver 1 via the second infrared communicator 21. The power key 23 is pressed to turn on the power to the digital broadcast receiver 1, or to turn off the power. The number pad 24 includes keys assigned the numerals 0 to 9. The number pad 24 is used to input channel numbers and so forth. The channel key 25 is pressed to change the channel in a preset order.

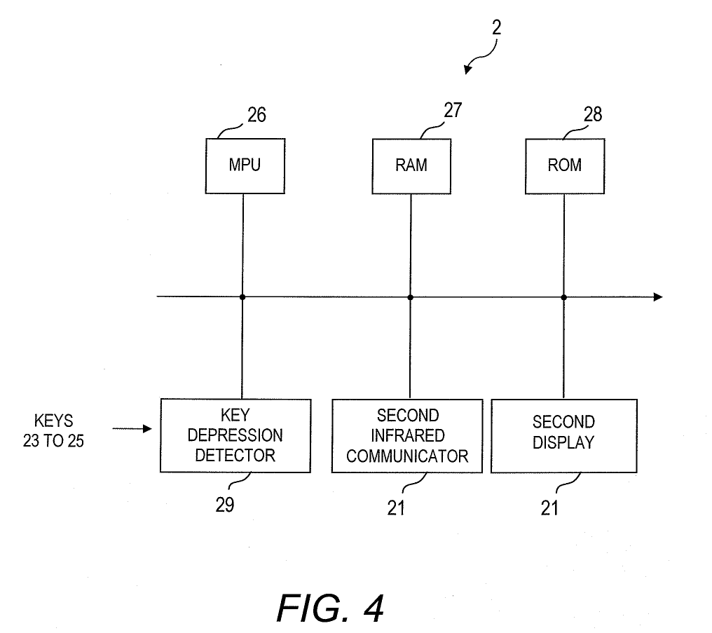

FIG. 4 is a block diagram illustrating an electrical configuration of the remote 2. The remote 2 includes an MPU (Micro Processing Unit) 26, a RAM (Random Access Memory) 27, a ROM (Read Only Memory) 28, and a key depression detector 29. The MPU 26 controls the operation of the entire remote 2. The RAM 27 temporarily stores key identification information for identifying a key operated and other such information.

The ROM 28 stores a control program for operating the MPU 26. The key depression detector 29 detects that the power key 23, the number pad 24, the channel key 25, or other keys shown in FIG. 3 have been pressed. The key depression detector 29 outputs an operation detection signal corresponding to each key to the MPU 26.

When the operation detection signal is received from the key depression detector 29, the MPU 26 produces a corresponding operation signal. Then, the MPU 26 sends the corresponding operation signal through the second infrared communicator 21 to the digital broadcast receiver 1. The MPU 26 also displays the channel information, the genre information, the character information, and so forth when such information has been received from the digital broadcast receiver 1 via the second infrared communicator 21.

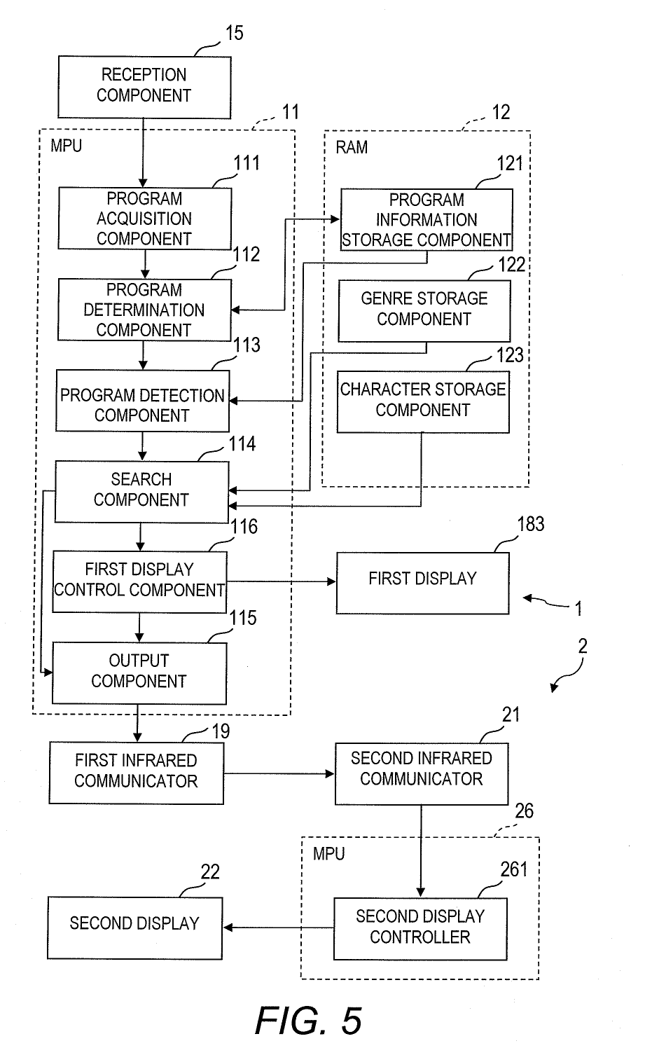

FIG. 5 is a block diagram illustrating a functional configuration of the broadcast receiving system 100. The MPU 11 of the digital broadcast receiver 1 functionally includes a program acquisition component 111, a program determination component 112, a program detection component 113, a search component 114, an output component 115, and a first display control component 116 (e.g., display control component). The RAM 12 functionally includes a program information storage component 121, a genre storage component 122, and a character storage component 123. The MPU 26 of the remote 2 functionally includes a second display controller 261 (e.g., display control component).

The MPU 11 reads and executes a control program that has been pre-stored in the ROM 13, etc., shown in FIG. 2. Then, the MPU 11 functions as the program acquisition component 111, the program determination component 112, the program detection component 113, the search component 114, the output component 115, the first display control component 116, or another such functional component. The MPU 11 also causes the RAM 12 to function as the program information storage component 121, the genre storage component 122, the character storage component 123, or another such functional component. The MPU 26 reads and executes a control program that has been pre-stored in the ROM 28, etc., shown in FIG. 4. Then, the MPU 26 functions as the second display controller 261 or another such functional component.

Data stored in the RAM 12 and ROM 13 or in the RAM 27 and ROM 28 can be stored on a removable recording medium such as a hard disk, optical disk, flexible disk, CD (Compact Disk), DVD (Digital Versatile Disk), semiconductor memory, or the like. In this case, the data can be readable by a hard disk drive, optical disk drive, flexible disk drive, silicon disk drive, cassette medium reader, or other such driver.

The program information storage component 121 stores program information for each receivable program. The program information includes channel information, program schedule information, program name information, genre information and character information. The channel information is information identifying a channel. The program schedule information includes program start time information and program end time information. The program start time information indicates a start time of a program. The program end time information indicates an end time of a program. The program name information indicates a name of a program. The genre information indicates a genre of a program, such as sports, drama, movies, animation and other such genre. The genre information is set for each program in an EPG (Electronic Program Guide) acquired by the program acquisition component 111. The character information indicates names of actors or characters appearing in a program. The character information is set for each program in the EPG acquired by the program acquisition component 111.

Also, if the program determination component 112 determines that the program information newly acquired by the program acquisition component 111 (hereinafter referred to as “newly acquired program information”) does not match the program information already stored in the program information storage component 121 (hereinafter referred to as “already stored program information”), then the program information storage component 121 stores the newly acquired program information instead of the already stored program information.

The genre storage component 122 stores preset genre information. The preset genre information is information indicating a genre of a program. Specifically, the preset genre information is set ahead of time based on the operation input received from the remote 2, and stored in the genre storage component 122. The user sets the preset genre information from among sports, drama, movies, animation and other such genre information based on the user's interest. Then, the preset genre information is stored in the genre storage component 122.

The character storage component 123 stores preset character information. The preset character information is information indicating names of characters appearing in a program. Specifically, the preset character information is set ahead of time based on the operation input received from the remote 2, and stored in the character storage component 123. The user sets the preset character information from among name information of actors appearing in a program, character name information and so forth based on the user's interest. Then, the preset character information is stored in the character storage component 123.

The program acquisition component 111 acquires the EPG (Electronic Program Guide) information via the reception component 15 at a preset timing (such as at specific time intervals (say, every 30 seconds)). Then, the program acquisition component 111 acquires the program information for each receivable program.

The program determination component 112 determines whether or not the newly acquired program information matches the already stored program information. If the program determination component 112 determines that the newly acquired program information does not match the already stored program information, then the program determination component 112 stores the newly acquired program information in the program information storage component 121 instead of the already stored program information.

The program detection component 113 detects updated programs when it is determined by the program determination component 112 that the newly acquired program information does not match the already stored program information. The updated programs are programs that are included in the newly acquired program information but not included in the already stored program information. In other words, the program detection component 113 detects the program information of programs that are newly added and the program information of programs that are updated.

The search component 114 searches for matching programs from among the receivable programs stored in the program information storage component 121 when the power has been turned on to the digital broadcast receiver 1. The matching programs are currently receivable programs having the genre information that matches the preset genre information or having the character information that matches the preset character information. Then, the search component 114 acquires the channel information, the program name information, the genre information, and the character information corresponding to the matching programs. Whether or not a program is currently receivable is determined from the current time and from the program schedule information stored in the program information storage component 121.

The search component 114 also searches for the matching programs when the program determination component 112 determines that there is no match. Then, the search component 114 acquires the channel information, the program name information, the genre information, and the character information corresponding to the matching programs.

The output component 115 outputs the channel information, the program name information, the genre information, and the character information of the matching programs acquired by the search component 114 to the remote 2 via the first infrared communicator 19.

The first display control component 116 displays the channel information of the matching programs acquired by the search component 114 on the first display 183. The first display control component 116 displays the channel information of the matching programs on the first display 183 in the smallest viewable size (such as a size of 10×10 mm on the screen), on the edge of the screen (such as the upper right corner), and for a short time (such as 10 seconds), so as not to impair the visibility of the program.

The second display controller 261 receives the program information (e.g., the channel information, the program name information, the genre information, and the character information) of the matching programs outputted from the output component 115 via the second infrared communicator 21. Then, the second display controller displays the program information for a specific preset length of time (such as 60 seconds) preset according to the second display 22. Also, when the program information of the matching programs is received from the output component 115, the second display controller 261 causes the second display 22 to flash for a specific preset length of time (such as 3 seconds).

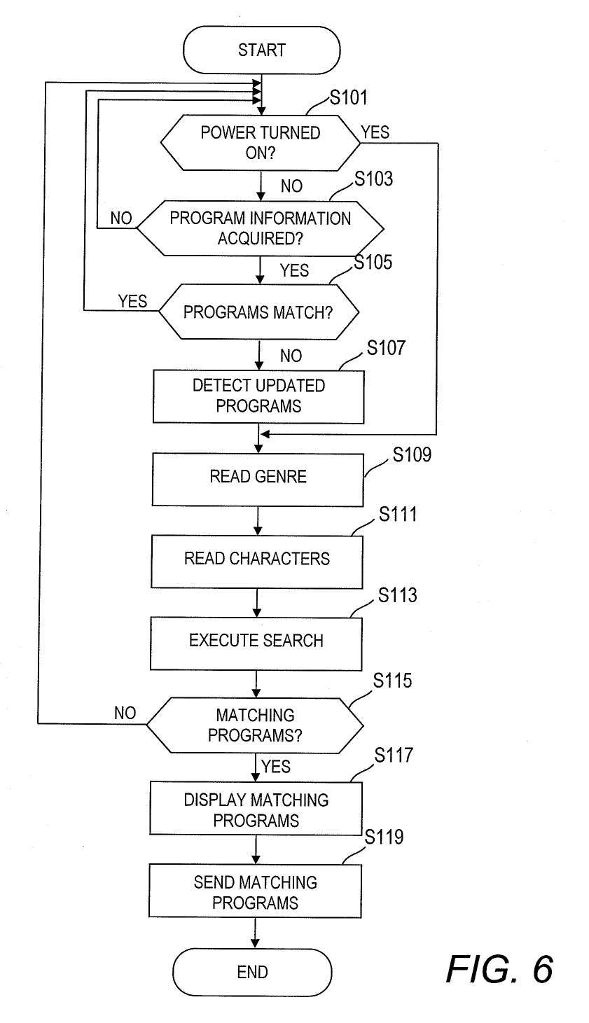

FIG. 6 is a flowchart illustrating an operation of the digital broadcast receiver 1. First, the search component 114 determines whether or not the power has been turned on to the digital broadcast receiver 1 (S101). If it is determined that the power has been turned on (Yes in S101), then the processing proceeds to step S109. If it is determined that the power has already been turned on (No in S101), then it is determined whether or not the program information has been acquired by the program acquisition component 111 (S103). If it is determined that the program information has not been acquired (No in S103), then the processing returns to step S101, and the processing from step S101 is repeated.

If it is determined that the program information has been acquired (Yes in S103), then the program determination component 112 determines whether or not the newly acquired program information acquired in step S103 matches the already stored program information (S105). If it is determined that there is a match (Yes in S105), then the processing returns to step S101, and the processing from step S101 is repeated. If it is determined that there is no match (No in step S105), then the program detection component 113 detects the program information of newly added programs and the program information of updated programs from the newly acquired program information (S107).

Once the processing is concluded in step S107, or if the answer is Yes in step S101, then the search component 114 reads the preset genre information stored in the genre storage component 122 (S109). Then, the search component 114 reads the preset character information stored in the character storage component 123 (S111). Then, the search component 114 searches for the matching programs from among the receivable programs stored in the program information storage component 121 (or the programs detected in step S107) (S113).

The output component 115 determines whether or not a matching program was found in step S113 (S115). If it is determined that no matching programs are found (No in S115), then the processing returns to step S101. Then, the processing from step S101 is repeated. If it is determined that matching programs are found (Yes in S115), then the first display control component 116 displays the channel information of the matching programs on the first display 183 (S117). Then, the output component 115 outputs the channel information, the genre information, and the character information of the matching programs to the remote 2 (S119). Then, the processing is concluded.

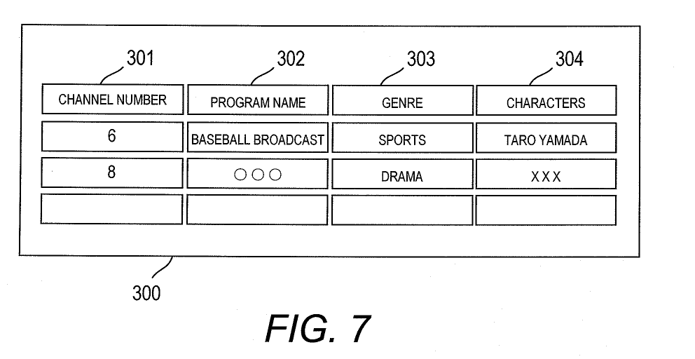

FIG. 7 is a screen shot illustrating a matching program display screen 300 displayed on the second display 22. The matching program display screen 300 includes a channel number display component 301, a program name display component 302, a genre display component 303 and a character display component 304. The channel number display component 301, a program name display component 302, a genre display component 303 and a character display component 304 are displayed from left side to right side of the matching program display screen 300. The channel number display component 301 displays the channel numbers of matching programs. The program name display component 302 displays the names of matching programs. The genre display component 303 displays the genres of matching programs. The character display component 304 displays names of the characters corresponding to the character information stored in the character storage component 123 out of the characters of the matching programs. The channel number display component 301, the program name display component 302, the genre display component 303 and the character display component 304 are displayed correspondingly for each matching program (in the same horizontal row here). In other words, the program name information, the genre information and the character information are displayed according to the channel information.

With the broadcast receiving system 100, the program information including the channel information and program schedule information is stored for each receivable program. The broadcast receiving system 100 searches for the matching programs. Then, the channel information corresponding to the matching programs is acquired. The channel information of the matching programs is outputted to the remote 2. The remote 2 receives the channel information of the matching programs and displays the channel information on the second display 22. Therefore, visibility of a program is ensured and channel selection becomes easier.

Specifically, since the channel information of the matching programs is displayed on the second display 22, the visibility of the program displayed on the first display 183 can be ensured. Furthermore, since the channel information of the matching programs can be used to select the channel, it is easier to select the channel.

Also, the matching programs that are currently receivable and that match preset conditions are searched for when the power has been turned on to the digital broadcast receiver 1. Thus, the channel information of the matching programs can be displayed on the second display 22 of the remote 2 when the power is switched on. Therefore, the visibility of the program is ensured and the channel selection becomes easier.

Furthermore, the program information is acquired via the reception component 15 at the preset timing. Then, it is determined whether or not the newly acquired program information matches the already stored program information. If it is determined that there is no match, then the broadcast receiving system 100 detects the updated programs. Furthermore, the broadcast receiving system searches for the matching programs from among the updated programs. Thus, the visibility of the program is ensured and the channel selection becomes even easier.

Specifically, the matching programs are searched for among the detected updated programs. Thus, every time the updated programs are detected and the matching programs are included in the updated programs, the channel information of the matching programs is displayed on the second display 22 of the remote 2. Thus, the visibility of the program is ensured and the channel selection becomes even easier.

In addition, the preset genre information is stored in the genre storage component 122. Then, programs having the genre information that matches the preset genre information are searched for as the matching programs. Thus, the channel selection becomes even more easily.

Specifically, the preset genre information is stored ahead of time based on the user's interest. Thus, any programs having the genre information that matches the preset genre information are searched for as the matching programs. Thus, the channel selection becomes even more easily.

Also, the genre information of the matching programs is outputted to the remote 2 according to the channel information. Then, the transmitted genre information is received and displayed on the second display 22 of the remote 2 according to the channel information. Thus, the visibility of the program is ensured and the channel selection becomes even more easily.

Furthermore, the preset character information is stored in the character storage component 123. Then, any programs having the character information that matches the preset character information are searched for as the matching programs. Thus, the channel selection becomes even more easily.

Specifically, the preset character information is stored ahead of time based on the user's interest. Thus, any programs having the character information that matches the preset genre information are searched for as the matching programs. Thus, the channel selection becomes even more easily.

In addition, the character information of the matching programs is outputted to the remote 2 according to the channel information. Then, the transmitted character information is received and displayed on the second display 22 of the remote 2 according to the channel information. Thus, the visibility of the program is ensured and channel selection becomes even more easily.

Also, when the channel information of the matching programs outputted from the digital broadcast receiver 1 is received, the second display 22 flashes for a specific preset length of time. Thus, the user can more easily see that the channel information of matching programs has been received. Therefore, the visibility of the program is ensured and the channel selection becomes even more easily.

Furthermore, since the channel information of the matching programs is displayed on the first display 183 of the digital broadcast receiver 1, the channel selection becomes even more easily.

Specifically, the channel information of the matching programs is displayed on the first display 183 of the digital broadcast receiver 1 and on the second display 22 of the remote 2. Thus, even if the user cannot see the second display 22 on the remote 2 (such as when the remote 2 is not located near the user), the channel information of the matching programs displayed on the first display 183 can still be viewed. Thus, the channel selection becomes even more easily.

Here, the first display 183 displays the channel information of the matching programs in the smallest viewable size on the edge of the screen for a short time. Thus, the visibility of the program can be ensured.

The broadcast receiver 1 can be any type of broadcast receiving device that receives television broadcasts and outputs the television broadcasts to the first display 183 so that the television broadcasts are visible from outside. For instance, the broadcast receiving device can be a device that receives analog broadcasts or both analog and digital broadcasts. However, the program information needs to be acquired via EPG (Electronic Program Guide) information or the like.

The first display 183 can be configured as a device that is separate from the digital broadcast receiver 1. For example, the first display 183 can be a monitor provided to a personal computer or the like.

At least one of the preset genre information and the preset character information can be set based on operation input received from the user via the remote or the like, and stored in the genre storage component 122 and the character storage component 123, respectively. In this case, the channel selection becomes even more easily.

In the embodiment, the matching programs are searched for among currently receivable programs. However, the search component 114 can search for the matching programs from among programs that are receivable within a specific time (such as 10 minutes) from the current time. In this case, the channel selection becomes even more easily.

In the embodiment, the search component 114 searches for the matching programs based on the preset genre information and the preset character information. However, the search component 114 can search for the matching programs based on other information. For instance, the search component 114 can search for the matching programs based on the program name information.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A broadcast receiving system comprising:
a broadcast receiving device configured to receive a television broadcast, the broadcast receiving device including
a program information storage component configured to store program information that includes channel information identifying channels of receivable programs and program schedule information indicating schedules of the receivable programs,
a search component configured to search for a matching program out of the receivable programs based on the program schedule information, and acquire the channel information corresponding to the matching program, and
an output component configured to output the channel information corresponding to the matching program; and
a remote control configured to communicate with the broadcast receiving device, the remote control including
a display component, and
a display control component configured to acquire the channel information outputted by the output component and display the channel information on the display component.

2. The broadcast receiving system according to claim 1, wherein
the program information storage component of the broadcast receiving device is further configured to store program start time information indicating start times of the receivable programs and end time information indicating end times of the receivable programs as part of the program schedule information.

3. The broadcast receiving system according to claim 1, wherein
the search component of the broadcast receiving device is further configured to search for the matching program in response to the power has been turned on to the broadcast receiving device.

4. The broadcast receiving system according to claim 3, wherein
the broadcast receiving device further includes
a program acquisition component configured to acquire the program information via the television broadcast at a preset timing,
a program determination component configured to determine whether or not the program information acquired by the program acquisition component matches the program information stored in the program information storage component, and
a program detection component configured to detect updated programs, which are included in the program information acquired by the program acquisition component but not currently included in the program information stored in the program information storage component, when the program determination component determines that the program information acquired by the program acquisition component does not match the program information stored in the program information storage component, and
the search component of the broadcast receiving device is further configured to search for the matching program when the program determination component determines that the program information acquired by the program acquisition component does not match the program information stored in the program information storage component.

5. The broadcast receiving system according to claim 1, wherein
the broadcast receiving device further includes
a program acquisition component configured to acquire the program information via the television broadcast at a preset timing,
a program determination component configured to determine whether or not the program information acquired by the program acquisition component matches the program information stored in the program information storage component, and
a program detection component configured to detect updated programs, which are included in the program information acquired by the program acquisition component but not currently included in the program information stored in the program information storage component, when the program determination component determines that the program information acquired by the program acquisition component does not match the program information stored in the program information storage component, and
the search component of the broadcast receiving device is further configured to search for the matching program when the program determination component determines that the program information acquired by the program acquisition component does not match the program information stored in the program information storage component.

6. The broadcast receiving system according to claim 1, wherein
the broadcast receiving device further includes
a genre storage component configured to store preset genre information indicating genres of programs and being preset in advance,
the program information storage component of the broadcast receiving device is further configured to store genre information indicating genres of the receivable programs as part of the program information, and
the search component of the broadcast receiving device is further configured to search for the matching program corresponding to the genre information that matches the preset genre information stored in the genre storage component.

7. The broadcast receiving system according to claim 6, wherein
the output component of the broadcast receiving device is further configured to output the genre information corresponding to the matching program to the remote control, and
the display control component of the remote control is further configured to receive the genre information outputted by the output component and display the genre information according to the channel information on the display component.

8. The broadcast receiving system according to claim 1, wherein
the broadcast receiving device further includes
a character storage component configured to store preset character information indicating names of characters appealing in programs and being preset in advance,
the program information storage component of the broadcast receiving device is further configured to store character information indicating names of characters appealing in the receivable programs as part of the program information, and
the search component of the broadcast receiving device is further configured to search for the matching program corresponding to the character information that matches the preset character information stored in the character storage component.

9. The broadcast receiving system according to claim 8, wherein
the output component of the broadcast receiving device is further configured to output the character information corresponding to the matching program to the remote control, and
the display control component of the remote control is further configured to receive the character information outputted by the output component and display the character information according to the channel information on the display component.

10. The broadcast receiving system according to claim 1, wherein
the display control component of the remote control is further configured to flash the display component for a specific length of time when the display control component receives the channel information corresponding to the matching program.

11. The broadcast receiving system according to claim 1, wherein
the broadcast receiving device further includes
a display component configured to output the television broadcast, and
a display control component configured to display the channel information corresponding to the matching programs on the display component of the broadcast receiving device.

12. The broadcast receiving system according to claim 1, wherein
the broadcast receiving device further includes
a genre storage component configured to store preset genre information indicating genres of programs and being preset in advance,
a character storage component configured to store preset character information indicating names of characters appealing in programs and being preset in advance,
the program information storage component of the broadcast receiving device is further configured to store genre information indicating genres of the receivable programs and character information indicating names of characters appealing in the receivable programs as part of the program information, and
the search component of the broadcast receiving device is further configured to search for the matching program corresponding to at least one of the genre information that matches the preset genre information stored in the genre storage component and the character information that matches the preset character information stored in the character storage component.

13. A broadcast receiving device for receiving a television broadcast, comprising:
a program information storage component configured to store program information that includes channel information identifying channels of receivable programs and program schedule information indicating schedules of the receivable programs;
a search component configured to search for a matching program out of the receivable programs based on the program schedule information, and acquire the channel information corresponding to the matching program; and
an output component configured to output the channel information corresponding to the matching program so that the channel information is displayed on a display component of a remote control.

14. A broadcast receiving method for receiving a television broadcast, comprising:
providing program information that includes channel information identifying channels of receivable programs and program schedule information indicating schedules of the receivable programs;
searching for a matching program out of the receivable programs based on the program schedule information;
acquiring the channel information corresponding to the matching program; and
outputting the channel information corresponding to the matching program so that the channel information is displayed on a display component of a remote control.
